(19) United States
(12) Patent Application Publication
(10) Pub. No.: US 2003/0184497 A1
(43) Pub. Date: Oct. 2, 2003

(54) Cylindrical Fresnel zone antenna with reflective ground plate

(76) Inventors: Chunfei Ye, Singapore (SG); Erping Li, Singapore (SG)

Correspondence Address: COATS & BENNETT, PLLC, P O BOX 5, RALEIGH, NC, 27602, US

(21) Appl. No.: 10/214,826

(22) Filed: Aug. 8, 2002

(30) Foreign Application Priority Data
Mar. 27, 2002 (SG) 200201761-4

(51) Int. Cl. H01Q 15/02; H01Q 19/06

(52) U.S. Cl. 343/909; 343/753

(57) ABSTRACT

An antenna employs cylindrical Fresnel zone plate (CFZP) construction in combination with a reflective ground plate and a sectorial reflector to enhance antenna gain, while lowering assembly cost and improving antenna placement flexibility. By forming a surface of symmetry for the antenna, the ground plate allows the antenna to mimic the operation of a symmetrical CFZP antenna using only half the nominal number of Fresnel elements. Further, the sectorial reflector restricts radiated emissions over a desired sector angle, minimizing radiation in undesirable directions, such as toward mounting walls or other nearby surfaces that would cause unwanted signal reflections, such as might aggravate multipath signal phenomenon.

### BACKGROUND OF THE INVENTION

The present invention generally relates to antennas for electromagnetic signal reception and transmission, and particularly relates to cylindrical Fresnel zone plate (CFZP) antennas.

Antennas form integral elements in essentially all communication systems or devices. One notes that antennas run the gamut in terms of size, shape, and configuration, in dependence on intended use, cost considerations, and the involved signals of interest. Despite such physical variations, a common set of performance parameters generally apply to essentially all antenna types. Antenna gain and directionality are, for example, properties generally of some importance.

CFZP antennas are a type of antenna exhibiting relatively good gain characteristics. In contrast to flat Fresnel zone plate antennas, which comprise a supporting disc with an array of concentric Fresnel rings, CFZPs use a cylinder to support a vertical array of metallic rings acting as Fresnel zones. Such antennas exhibit a generally good omni-directional horizontal signal, making them suitable for use in certain communication system applications.

However, this omni-directionality is not always desirable, particular where there is a need to restrict signal radiation in particular directions, such as might be desired where reflective surfaces would otherwise contribute to multipath signal problems. Indoor wireless network installations represent such an environment.

Further, typical implementations of CFZP antennas require some number of discrete Fresnel elements spaced apart in accordance with the signal frequencies and gain requirements at hand. These implementation requirements sometimes result in undesirably large and, consequently undesirably awkward, and possibly expensive, antennas.

### BRIEF SUMMARY OF THE INVENTION

The present invention provides an apparatus for implementing an efficient cylindrical Fresnel zone plate (CFZP) antenna having good signal gain, low cost, compact package, and directional radiation. In an exemplary embodiment, the inventive antenna is constructed as a sectorial cylindrical Fresnel zone plate (S-CFZP) antenna. In such embodiments, the antenna comprises a ground plate, a dielectric support positioned perpendicular to the base, a plurality of Fresnel elements arrayed in vertically spaced apart fashion on an inner face of the dielectric support, a sectorial reflector positioned on an outer face of the support, and a feeder positioned on the base at the foci of the Fresnel elements.

The dielectric support is generally cylindrically shaped, and might comprise a cylindrical sector or a complete right circular cylinder. Likewise, the Fresnel elements are generally cylindrically shaped flat hoops or rings, and might be complete or partial hoops. In some embodiments, both the dielectric support and the Fresnel elements form cylindrical sectors, though not necessarily at the same sector angles. In other embodiments, one or both the support and Fresnel elements form complete cylinders. Further, the arrangement of Fresnel elements on the inner face of the dielectric support varies between embodiments, and it is not necessary to maintain the same number of Fresnel elements, or to use uniform spacing between them. Implementation details regarding placement and spacing of the Fresnel elements may be varied as needed.

Regardless of the number or spacing of the Fresnel elements, the ground plate acts as a reflective surface lying parallel to the Fresnel elements, which placement allows it to function as a surface of symmetry. With this surface of symmetry, the antenna operates as if an additional, symmetric plurality of Fresnel elements is implemented on a side opposite the ground plate. As such, the antenna offers the performance advantage of symmetric pluralities of Fresnel elements, but with only half the number Fresnel elements required for symmetry physically implemented. Attendant cost and size advantages flow from the use of the reflective ground plate.

Further operating advantages derive from using the sectorial reflector. Positioned on the outer face of the dielectric support over a desired cylindrical sector angle, the reflector serves at least a twofold purpose. First, the reflector enhances antenna gain by reflecting electromagnetic signals from or to the feeder through the portions or bands of the dielectric support not covered by the Fresnel elements. Second, the reflector blocks backward radiation through the portion of the dielectric support covered by the reflector. Thus, the otherwise omni-directional horizontal radiating pattern of the antenna is restricted to a desired sector, or, more appropriately, is blocked over a desired sector angle, by use of the sectorial reflector.

Use of the inventive antenna structure is not limited to a particular application, or even to a range of applications. However, it is expected that the present invention will be applied to antenna structures for use in wireless LAN communications, broadcast satellite reception, mobile communication, and various other wireless networking and communication applications. For example, the ability to restrict or otherwise reduce radiated energy in a given sector with the inventive antenna structure facilitates its use in wireless LAN applications, where it may be undesirable to radiate energy toward a mounting wall or other surface on which the antenna is positioned, because radiation in those directions generally produces reflective waves that exacerbate multi-path, propagation within the indoor environment.

### BRIEF DESCRIPTION OF THE DRAWINGS

FIG. 1 is a diagram of a conventional CFZP antenna implemented as a full cylinder.

FIG. 2A is a diagram of a CFZP antenna implemented as a partial cylinder.

FIG. 2B is a diagram illustrating a surface of symmetry as used to modify CFZP antenna structures according to some embodiments of the present invention.

FIG. 3 is a diagram illustrating the electromagnetic image principle employed by exemplary embodiments of the present invention.

FIG. 4. is a diagram of an exemplary embodiment of a sectorial CFZP (S-CFZP) according to the present invention.

FIG. 5 is a diagram of another exemplary embodiment of a S-CFZP antenna.

FIG. 6 is a diagram of another exemplary embodiment of a S-CFZP antenna.

FIG. 7 is a diagram illustrating a variation of the antenna of FIG. 6.

FIG. 8 is a diagram illustrating another variation of the antenna of FIG. 5.

FIGS. 9A-9D are diagrams illustrating a few of the variations possible for the ground plate used in exemplary S-CFZP antennas.

FIG. 10 illustrates an exemplary segmented variation of an S-CFZP antenna.

### DETAILED DESCRIPTION OF THE INVENTION

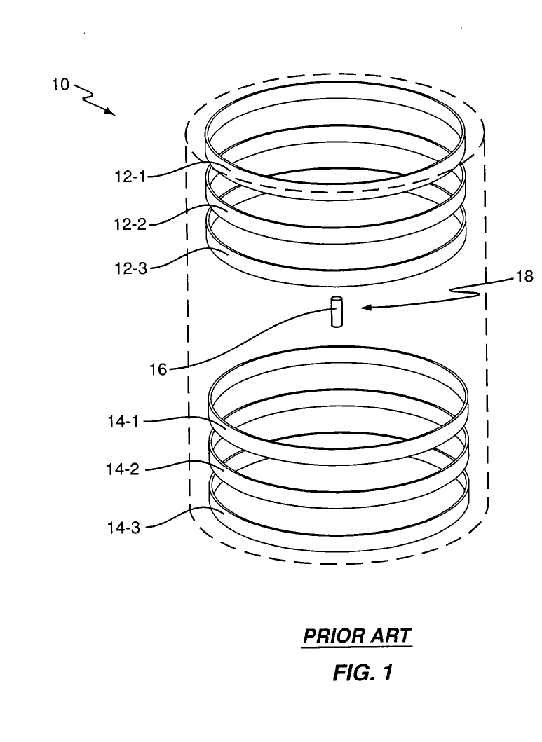

FIG. 1 illustrates a conventional Cylindrical Fresnel Zone Plate (CFZP) antenna 10. Such antennas utilize symmetric Fresnel zones 12 and 14 that are disposed in upper and lower vertical arrays on the inner face of a cylindrical support 18, where the radii of the Fresnel zones 12 and 14 are the focal length of the antenna 10. Traditionally, antennas of this type are either complete or half cylinders and provide omni-directional horizontal radiation pattern centered at the feeder 16. When placed inside a building, such as in wireless LAN communications, the omni-direction radiation of the antenna 10 exacerbates multipath signal propagation because of, among other things, potentially strong signal reflections from reflective surfaces nearby the antenna 10.

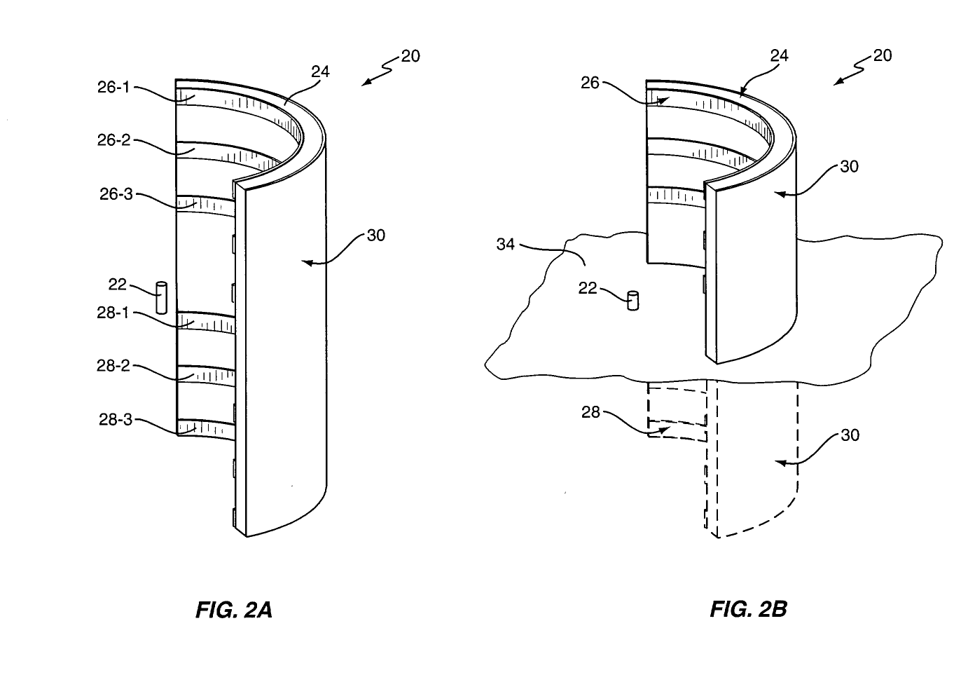

FIGS. 2A and 2B illustrate exemplary embodiments of an antenna 20 according to the present invention. In FIG. 2A, the antenna 20 comprises a feeder 22, a dielectric support 24, upper Fresnel elements 26, e.g., 26-1, 26-2, and so on, symmetric lower Fresnel elements 28, e.g., 28-1, 28-2, and so on, and a sectorial reflector 30. Use of the reflector 30 enhances directional radiation from the inner face of the support 24, i.e., the support surface facing the feeder 22, and blocks outward radiation from the antenna 20 over the portion of the support's outside face that is covered by the reflector 30. In this manner, the antenna 20 can be mounted to a reflective surface, such as a wall, without it strongly radiating into the wall and thereby causing unwanted signal reflections.

The thickness of the support 24 determines the distance separating the Fresnel elements 26 and 28 from the reflective surface 30. Ideally, this thickness is configured as λₘ/4, where λₘ represents the wavelength of a frequency of interest within the dielectric material. With the dielectric thickness set appropriately, radiated signals reflecting from the facing surfaces of the Fresnel elements 26 and 28, and those signals reflecting from the reflector 30, which must pass through the dielectric 24 twice, constructively interfere to enhance antenna gain. Thus, the reflector 30 aids antenna gain, as well as directly blocking unwanted rearward antenna emissions.

FIG. 2B illustrates a further refinement of the antenna of FIG. 2A with the introduction of ground plate 34, which enables antenna 20 to eliminate the Fresnel elements 28 below the ground plate 34 by employing the “image principle” known by those skilled in the art of electromagnetic theory. Here, the ground plate 34 serves as a reasonable approximation of a perfectly conductive, infinite ground plane provided that it sized large enough relative to the dimensions of the Fresnel elements 26 and made of suitable conductive material, such as zinc, brass, aluminum, steel, etc.

With the ground plate 34 positioned parallel to the Fresnel elements 26 as shown, the antenna 20 mimics the symmetrical Fresnel element configuration shown in FIG. 2A, but with only the upper Fresnel elements 26 physically implemented. That is, with the ground plate 34 operating as a reflective surface for the antenna 20, one need only implement one half of the symmetrical pluralities of Fresnel elements 26 and 28 otherwise required for symmetric operation.

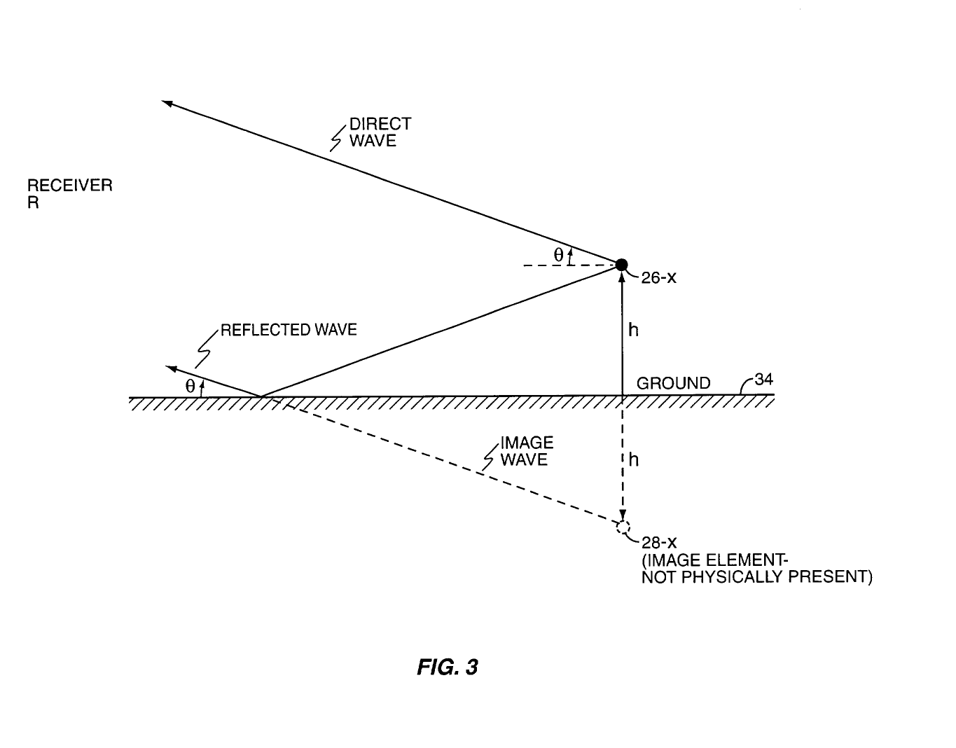

FIG. 3 illustrates such antenna operation in more detail, and demonstrates use of the image principle as a basis for analyzing the field behavior of the antenna 20. Only one Fresnel element 26−x (x=1, 2, 3, etc.) is shown in simplified form relative to the ground plate 34, along with the corresponding Fresnel element 28−x, which is not physically present but rather is depicted as the “mirror image” of element 26−x. Thus, where Fresnel element 26−x occupies a position at height “h” above the ground plate 34, the image element 28−x is assumed to occupy a mirror position at height h below the ground plate 34.

From the perspective of a receiver R, the resultant field from antenna 20 depends on the direct wave from Fresnel element 26−x in combination with the reflected wave from the ground plate 34. Using the image principle, the reflected wave may be assumed to radiate from the mirror image element 28−x. Thus, one obtains the field at the receiver R by analyzing the problem based on the assumption that Fresnel element 28−x is physically present, and is driven by a current relevant to that driving Fresnel element 26−x. The resultant field pattern of antenna 20 if implemented with symmetric sets of Fresnel elements 26 and 28 but without the ground plate 34, is essentially the same when antenna 20 is implemented using just one set of Fresnel elements in combination with the ground plate 34.

Of course, those skilled in the art will recognize that use of the ground plate 34 may change the antenna impedance characteristics as compared to the free-space characteristics of Fresnel elements 26. As is well understood, such changes alter, for example, the required applied voltage for a given antenna power.

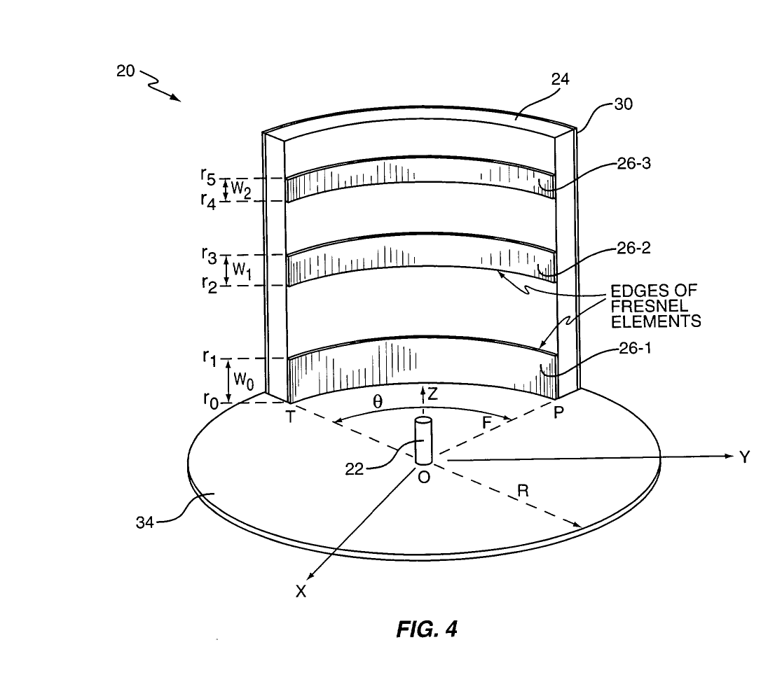

FIG. 4 illustrates an exemplary embodiment of the antenna 20 that takes advantage of the image principle. Here, the antenna 20 comprises one set of Fresnel elements (set 26), the ground plate 34, and the reflector 30. In such a configuration, the antenna 20 is relatively compact, i.e., only the upper set of symmetric Fresnel elements 26 is implemented, and directional by virtue of the reflector 30. One notes that the support 24, the Fresnel elements 26, and the reflector 30 are implemented here with the same cylindrical sector angle “TOP” defined by line segments “TO” and “OP.” Further, note the vertically spaced arrangement of the set of Fresnel elements 26 on the inner face of the support 24. The height from the ground plate 34 to the edge of each Fresnel element 26, i.e., individual elements 26-1, 26-2, and so on, relative to the feeder 22 is given by the equation,

$${r}_{n} = \sqrt{nF λ + {( \frac{n λ}{2} )}^{2}} , \qquad ( 1 )$$

where n equals the number of the particular edge of Fresnel elements 26 up to the Nth edge, F is the focal length of the antenna 20, and λ is the free-space wavelength of the electromagnetic signal of interest. Thus, Equation (1) may be used to set the relative spacing of the Fresnel elements 26. Additionally, where there are a total of I elements, the width (edge-to-edge) of the ith Fresnel element 26 is given as,

Wᵢ=r₂ᵢ₊₁−r₂ᵢ, (2)

where i=0, 1, 2, . . . , I, and Wᵢ the width (edge-to-edge) of the ith Fresnel element 26.

With the above configuration, antenna 20 forms a S-CFZP antenna structure having a sectorial reflector 30 positioned a wavelength-dependent distance behind the Fresnel element 26, and providing antenna gain and directionality control. While the reflector 30 is generally implemented as a partial cylindrical section (i.e., sector angle is less than 360 degrees), one or both the support 24 and the Fresnel elements 26 may be implemented as full or partial cylinders in any combination.

When configured as a transmitting antenna, the feeder 22 functions as a radiating element, thereby serving as a radiating signal source for the antenna 20. The Fresnel elements 26 direct the electromagnetic energy such that it is radiated outward from the antenna 20. By positioning the reflector 30 behind the support 24, radiated energy is greatly reduced behind the antenna 20. Obviously, varying the size and position of the reflector 30 varies the areas relative to the antenna 20 at which radiated energy is controlled.

One of the many advantages in being able to define one or more areas of reduced radiation is that the antenna 20 may be mounted on a wall or other reflective surface, without significant electromagnetic energy radiating backwards toward the mounting surface. This reduction in backward-radiated energy reduces the amount of reflected energy from mounting surfaces, thereby reducing multi-path propagation associated with the desired signals radiating from the antenna 20. As noted earlier, radiation from the Fresnel elements 26 constructively interferes with the radiation from the reflector 30, yielding a higher gain than is generally available with conventional dipole and monopole antennas.

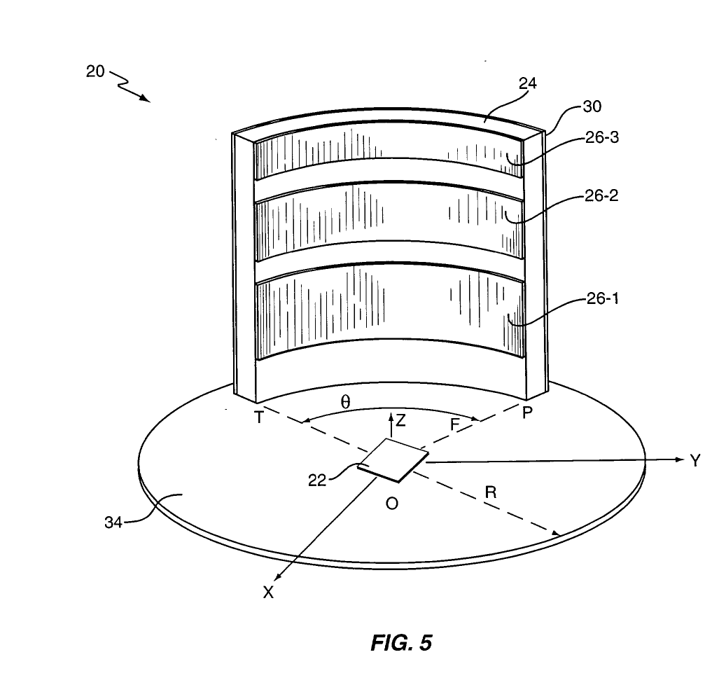

In general, the antenna 20 is subject to much variation in terms of its physical implementation. FIG. 5 illustrates several of these variations, where the placement of the Fresnel elements 26 is opposite that shown in FIG. 4, and where the monopole configuration of feeder 22 is replaced with a “microstrip” patch antenna configuration positioned at the foci of the Fresnel elements 26. As such, the microstrip patch antenna 22 can be mounted or otherwise fixed to the ground plate 34, but is not necessarily fixed to the ground plate 34. Of course, the feeder 22 is not limited to monopole or microstrip patch antenna configurations, and may be implemented using a variety of other antenna feeder configurations, including various dipole configurations.

In this particular configuration, the ground plate 34 comprises a circular disc, which may be solid or laminate in structure and preferably includes one or more conductive, planar layers, and which has a radius R substantially equal to the radius of curvature of the support 24. As such, the feeder 22 is positioned at the center of the ground plate 34. Of course, the feeder 22 may not be positioned at the geometric center of the ground plate 34 depending upon the shape of ground plate used.

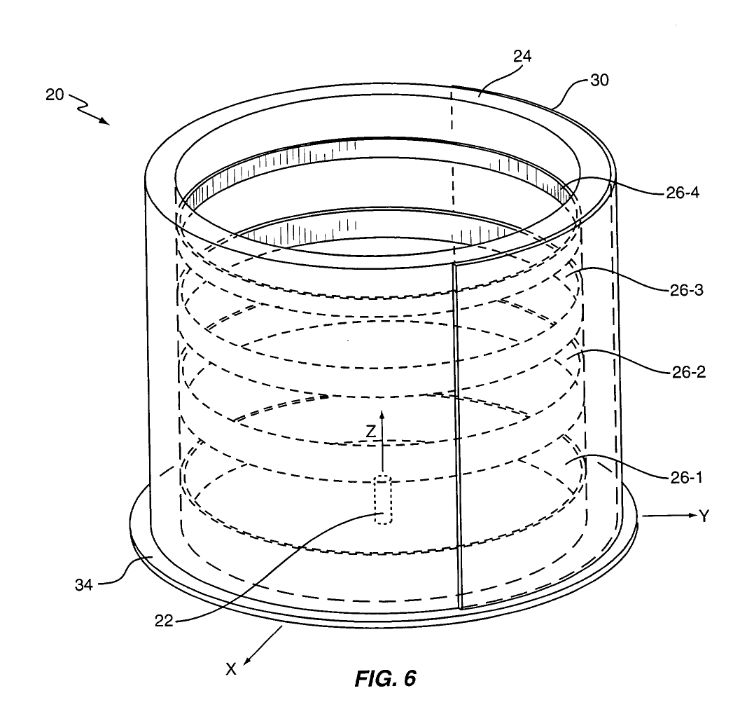

FIG. 6 illustrates further exemplary variations on the antenna 20. Here, the support 24 is implemented as a complete right circular cylinder, and the Fresnel elements 26 form complete cylindrical hoops facing the feeder 22 and are positioned on the inner cylindrical surface of the support 24. The reflector 30, however, retains its implementation as a partial cylinder, and covers the outer face of the support 24 over a desired sector angle. Again, outward radiation from the antenna 20 is substantially blocked by the reflector 30 over this desired sector angle, while the reflector's inward reflections toward the feeder 22 tend to boost antenna gain.

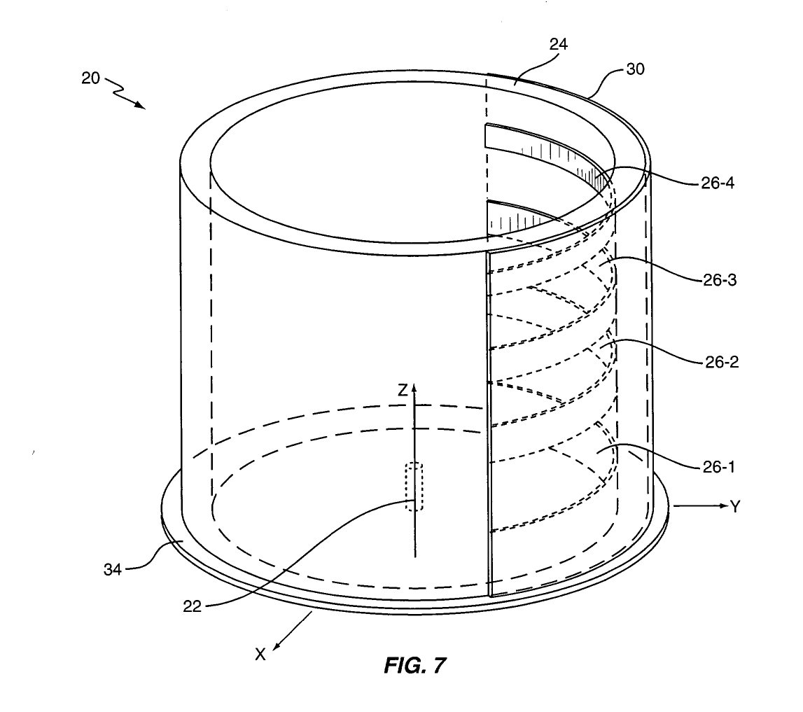

As was noted earlier, the support 24 and the Fresnel elements 26 may be implemented at essentially any sector angle between 0 degrees and 360 degrees, in any combination of sector angles between the support 24 and the Fresnel elements 26. That is, one or both the support 24 and Fresnel elements 26 may comprise a complete cylinder or a portion thereof, in any combination. FIG. 7 illustrates one such variation, and deviates from the antenna 20 shown in FIG. 6 with its implementation of a full cylindrical support 24 and sectorized Fresnel elements 26, i.e., partial cylindrical sections. While the sector angle of the Fresnel elements 26 is shown equal to the sector angle of the reflector 30, it should be understood that the two sector angles do not have to be equal. Indeed, the sector angle of the Fresnel elements 26 may be greater than or less than the reflector sector angle.

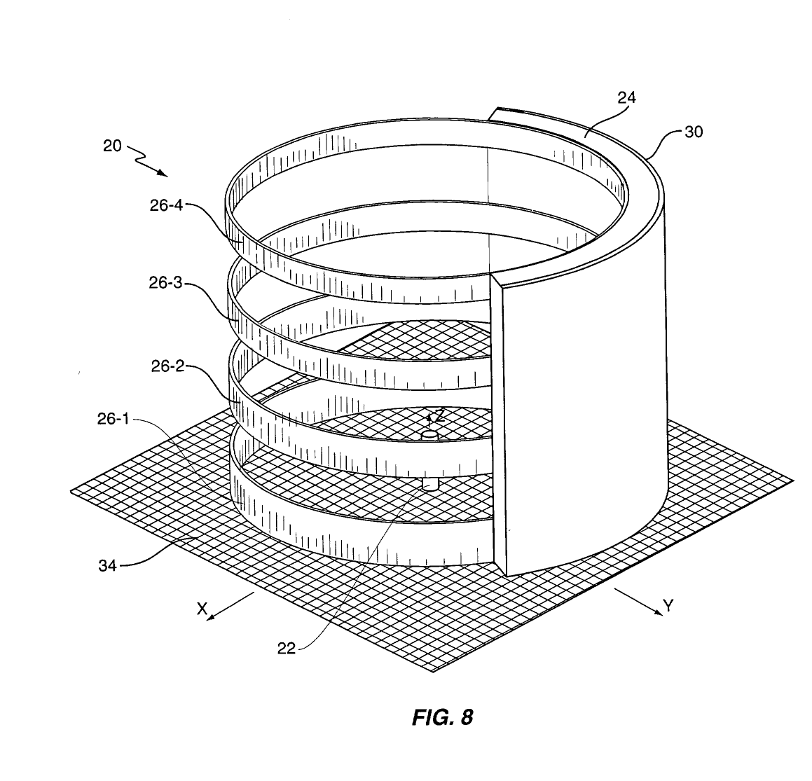

FIG. 8 illustrates yet another exemplary embodiment of the antenna 20 and, in converse relation to FIG. 7, illustrates the Fresnel elements 26 as comprising complete cylindrical hoops, while the support 24 comprises a cylindrical section. The sector angle of the support 24 is shown equal to that of the reflector 30, but it should be understood that the two sector angles do not need to be equal; the support's sector angle may be more or less than that of the reflector 30. While not shown, the forward portion of each Fresnel element 26, i.e., the portion of the loop diametrically opposite the support 24, might be supported by a dielectric rod or other structural element that may be supported by the ground plate 34.

As regards the ground plate 34, one notes that FIG. 8 illustrates a rectangular plate rather than the circular configurations shown in the other embodiments. In practice, variations on the extent and shape of the ground plate 34 are tolerated without significant changes in antenna performance. Of interest beyond the rectangular shape of ground plate 34 in this embodiment, one notes that ground plate 34 here is formed as a conductive wire mesh. In general, wire mesh can be used to form the ground plate 34 in essentially any shape, e.g., circle, rectangle, general polygon, or in some non-uniform shape. Of course, the same versatility in ground plate shape is available where the ground plate 34 is implemented as one or more planar layers of conductive material.

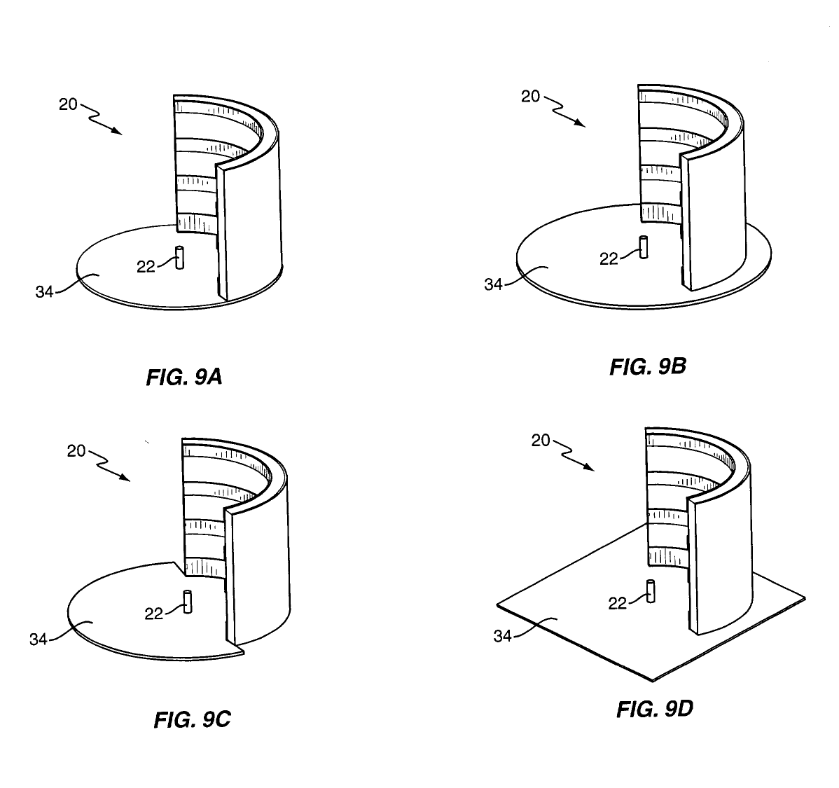

FIGS. 9A through 9D illustrate such shape-based variations on ground plate configurations, but it should be noted that such illustrations are not meant as an exhaustive catalog of all possible variations. Use of the ground plate 34 is in generally beneficial because it allows the antenna 20 to mimic symmetrical pluralities of Fresnel elements 26 and 28 without the need for physically implementing both sets; however, the specific size and shape of it are not overly significant, and it may be altered to suit usage considerations and practical convenience.

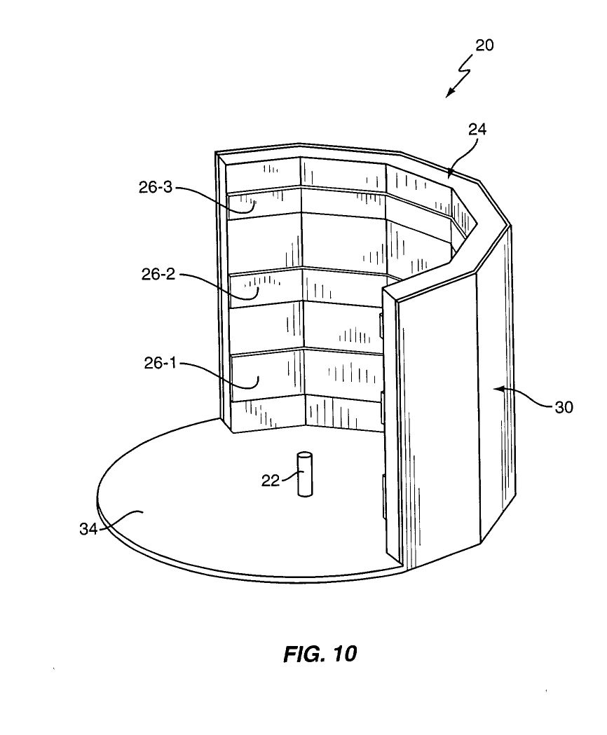

FIG. 10 illustrates implementation flexibility beyond ground plate shape and construction. FIG. 10 is an exemplary, segmented version of the antenna 20 wherein the Fresnel elements 26, the dielectric support 24, and the reflector 30 are segmented. Of course, variations on this segmenting approach include embodiments where, for example, the Fresnel elements 26 are segmented but the support 24 and reflector 30 remain curvilinear. In any case, ease of transportability and assembly/disassembly may be gained through segmenting portions of the antenna 20. For example, with the segmenting shown, the antenna 20 may be disassembled into a number of relatively small parts, thereby facilitating convenient transportation and storage.

Where the Fresnel elements 26 are implemented as a series of joined segments, the number of segments is chosen such that the segmented ring approximates an overall curved shape. Thus, by selecting an appropriate number of segments, the Fresnel elements 26 may be formed as a ring or partial ring that substantially conforms to the curvature desired for the dielectric support 24 on which they are mounted.

From the implementation variety illustrated by the included drawings, those skilled in the art will recognize that the inventive antenna 20 is subject to much variation. However, its underlying characteristics of directionality and relatively high gain are consistent across its range of implementations. As such, it should be appreciated that the foregoing information is exemplary only, and should not be construed as limiting the range of applications and the variations suitable for antenna 20. Indeed, the scope of the present invention is limited only by the scope of the following claims, and their reasonable equivalents.

What is claimed is:

1. An antenna comprising:
a generally curved dielectric support having inner and outer faces;
a plurality of spaced apart Fresnel elements disposed on the inner face of the dielectric support;
a reflective ground plate positioned adjacent the dielectric support to reflect radiated signals from the plurality of Fresnel elements; and
a feeder positioned at foci of the Fresnel elements.

2. The antenna of claim 1, further comprising a sectorial reflector covering an area of the outer face of the dielectric support.

3. The antenna of claim 2, wherein the feeder comprises a radiating source antenna, and wherein radiated signals from the radiating source antenna are reflected outward from the inner face of the dielectric support by the sectorial reflector and by the Fresnel elements.

4. The antenna of claim 1, wherein the dielectric support extends perpendicularly above the ground plate, and the reflective ground plate defines a plane extending outward from the inner face of the dielectric support.

5. The antenna of claim 1, wherein the dielectric support is cylindrically curved.

6. The antenna of claim 5, wherein the Fresnel elements are cylindrically curved to conform to the inner face of the dielectric support.

7. The antenna of claim 5, further comprising a sectorial reflector positioned on the outer face of the dielectric support, and wherein the sectorial reflector is cylindrically curved to conform to the outer face of the dielectric support.

8. The antenna of claim 1, wherein the dielectric support has a material-dependent thickness of approximately one-quarter wavelength relative to an electromagnetic signal frequency of interest.

9. The antenna of claim 1, wherein the dielectric support comprises at least a portion of a right circular cylinder.

10. The antenna of claim 9, wherein the Fresnel elements each comprise at least a portion of a right circular cylindrical ring.

11. The antenna of claim 1, wherein the ground plate comprises a conductive wire mesh.

12. The antenna of claim 1, wherein each Fresnel element comprises a series of segments joined to approximate a generally curved ring.

13. The antenna of claim 1, wherein a maximum segment length for the series of segments is chosen such that the joined segments substantially conform to a curvature of the inner face of the dielectric support.

14. The antenna of claim 1, wherein a width of each Fresnel element is a function of the distance of the Fresnel element from the reflective ground plate.

15. The antenna of claim 14, wherein the width is measured from a bottom edge of the Fresnel element to a top edge of the Fresnel element relative to the reflective ground plate.

16. The antenna of claim 14, wherein the widths of the Fresnel elements decrease with increasing distance from the reflective ground plate.

17. The antenna of claim 1, wherein one or more of the Fresnel elements comprises a plurality of joined segments.

18. The antenna of claim 1, wherein the dielectric support comprises a plurality of joined segments.

19. An antenna comprising:
a reflective ground plate;
a cylindrically curved dielectric support extending above the ground plate;
a plurality of spaced apart Fresnel elements disposed on an inner face of the dielectric support;
a feeder element adjacent to the ground plate at foci of the Fresnel elements; and
an electromagnetic reflector disposed on an outer face of the dielectric support, and covering at least a portion of the outer face over a desired cylindrical sector angle.

20. The antenna of claim 19, wherein the dielectric support has a material-dependent thickness that is approximately one-quarter wavelength of an electromagnetic signal frequency of interest, such that the Fresnel elements and the electromagnetic reflector are separated by approximately a material-dependent one-quarter wavelength for the frequency of interest.

21. The antenna of claim 19, wherein the dielectric support comprises a sector of a right circular cylinder having a first sector angle.

22. The antenna of claim 21, wherein the Fresnel elements each comprise a sector of a cylindrical band having second sector angles.

23. The antenna of claim 22, wherein the first sector angle of the dielectric support is greater than the second sector angles of the Fresnel elements.

24. The antenna of claim 22, wherein the first sector angle of the dielectric support is less than the second sector angle of the Fresnel elements.

25. The antenna of claim 22, wherein the dielectric support is a right circular cylinder, such that the first sector angle is 360 degrees.

26. The antenna of claim 25, wherein the Fresnel elements are complete cylindrical hoops spaced apart on the inner face of the dielectric support.

27. The antenna of claim 25, wherein the Fresnel elements are incomplete cylindrical hoops spaced apart on the inner face of the dielectric support.

28. The antenna of claim 19, wherein the Fresnel elements comprise a first plurality of Fresnel elements, and wherein the ground plate is a reflective ground plate acting as a surface of symmetry for the antenna, such that the antenna mimics a second plurality of Fresnel elements.

29. The antenna of claim 19, wherein the feeder comprises a monopole antenna.

30. The antenna of claim 19, wherein the feeder comprises a dipole antenna.

31. The antenna of claim 19, wherein the feeder comprises a microstrip patch antenna.

32. The antenna of claim 19, wherein the feeder comprises an electromagnetic source, such that electromagnetic energy radiated from the feeder is reflected outward relative to the inner face of the dielectric support by a combination of the Fresnel elements and the reflector.

33. The antenna of claim 32, wherein the reflector substantially blocks electromagnetic radiation over the desired cylindrical sector angle behind the outer face of the dielectric support.

34. The antenna of claim 19, wherein each of the Fresnel elements comprises a series of segments joined to form a least a portion of a cylindrically curved ring.

35. The antenna of claim 34, wherein a maximum segment length of each segment is limited such that the cylindrically curved ring substantially conforms to the cylindrically curved dielectric support.

36. The antenna of claim 19, wherein the ground plate comprises a conductive material.

37. The antenna of claim 36, wherein the conductive material is a wire mesh.

38. The antenna of claim 36, wherein the conductive material comprises a metallic plate.

39. The antenna of claim 19, wherein a width of each Fresnel element is a function of the distance of the Fresnel element from the reflective ground plate.

40. The antenna of claim 39, wherein the width is measured from a bottom edge of the Fresnel element to a top edge of the Fresnel element relative to the reflective ground plate.

41. The antenna of claim 39, wherein the widths of the Fresnel elements decrease with increasing distance from the reflective ground plate.

42. The antenna of claim 19, wherein each Fresnel element comprises a series of joined segments.

43. The antenna of claim 19, wherein the dielectric support comprises a series of joined segments.

44. The antenna of claim 19, wherein the reflector comprises a series of joined segments.
